(19) United States
(12) Patent Application Publication
(10) Pub. No.: US 2005/0267767 A1
(43) Pub. Date: Dec. 1, 2005

(54) Allowable states of policies

(76) Inventors: Carrie W. Searcey, Cary, NC (US); Eric F. Kirchstein, Raleigh, NC (US)

Correspondence Address: COATS & BENNETT, PLLC, P O BOX 5, RALEIGH, NC, 27602, US

(21) Appl. No.: 10/854,071

(22) Filed: May 26, 2004

(51) Int. Cl. F16F 7/10

(52) U.S. Cl. 705/1

(57) ABSTRACT

A policy is restricted from assuming certain states. A list of possible states for the policy is defined, and which of the defined states the policy is allowed to assume are specified. A policy enforcement point or selected enforcement points disallow the policy from assuming any state other than the specified allowable states. Specifying the allowable states may include defining an allowable states parameter, and assigning one or more values to the allowable states parameter indicative of the allowable states.

### BACKGROUND

The present invention relates generally to policies for software applications, network management, e-commerce or business and the like, and in particular to a system and method of controlling the states a policy may assume.

Pending patent application Ser. No. 10/707,408 filed Dec. 11, 2003, and assigned to the assignee of the present application, discloses a system and method for distributing policies. The disclosure of that application is incorporated by reference herein in its entirety.

Policies may be defined or developed to control software applications, network management, e-commerce or business or similar communication or data processing activities. Such policies may include “if-then” clauses or similar statements or definitions. An example of one policy may be “if some precondition, then perform some predefined action, or set some value or the like.” In another example, the policy may be “if some precondition and some other precondition or preconditions, then perform some predefined action, set some value or the like.”

Policies are defined through a lifecycle, which may comprise a plurality of states. Typical states of a policy lifecycle may be draft (open for edit); validation (testing and debugging); ready for deployment; and deployed. A deployed policy is one that is accessible to enforcement points for enforcement or implementation. Since all policies live through this lifecycle, any policy viewable or accessible through a policy editing tool can be deployed into a production environment. In many cases this is an undesirable capability. For example, a policy creation tool may ship with a plurality of example policies to assist users in creating their own policies. Such policies may be edited by users, but should never be deployed without modification, as their parameters and policy directives are unlikely to be compatible with the user's environment.

Additionally, deployed policies may be altered or disabled by users through a policy editing tool. This, too, is undesirable, as users may circumvent critical policy restrictions, or may even undeploy a policy altogether. For example, a software product may ship with a deployed policy crucial to its proper operation. The software creator may not wish to allow the policy to be undeployed, deleted, or edited. As another example, a policy, such as a digital rights management policy, may tie access to digital content (audio, video or the like) to authorized hardware, or to remuneration of the copyright owner. Allowing a user to undeploy or otherwise alter such a policy may facilitate piracy of the associated content.

### SUMMARY

The present invention relates to a method of restricting a policy from assuming certain states. The method includes defining possible states for the policy, and specifying which of the defined states are allowable states for the policy to assume. The method further includes disallowing, at an enforcement point or selected enforcement points, the policy from assuming any state other than the specified allowable states. Specifying the allowable states may include defining an allowable states parameter, and assigning one or more values to the allowable states parameter indicative of the allowable states.

### BRIEF DESCRIPTION OF DRAWINGS

FIG. 1 is a flow diagram of a method of restricting a policy from certain states.

FIG. 2 is functional block diagram of a policy control and implementation system according to one embodiment of the present invention.

### DETAILED DESCRIPTION

In general, a policy may be described as a course or method of action selected from among alternatives in light of given conditions to guide and determine present and future decisions. Virtually all businesses, institutions, and government agencies have a variety of policies that guide and govern management decisions and actions in light of conditions and circumstances. These policies may range from generalizations and truisms (e.g., “the customer is always right”) to detailed, written policies that form the basis of legal rights and responsibilities, such as policies regarding employment practices, customer relations, grievance resolution procedures, and the like.

The concept of formal, predetermined (e.g., written) policies has recently been applied to the operation, management and control of various information technologies. Some of these are known by particular names, such as Policy-Based Network Management (PBNM) to manage and control network resources; Role Based Access Control (RBAC) to govern personnel access to information technology resources based on an individual's role in an organization and the policies formulated for that role; Digital Rights Management (DRM), a policy-based system for controlling access to digital content such as audio and video files; and the like. In addition, the concept of policies has been applied to the distribution and control of software applications, e-commerce systems, data processing, and the like.

In most information technologies applications of policy-based control methods, the policies are not only written but also machine-readable to allow for automated implementation and enforcement. One common form of policy creation and management is a policy template wherein the policies—i.e., the conditional rules and schema that inform management and control decisions—are defined. A policy template may be defined by a policy administrator or the like. The policy template may be defined or formed as a structured document. For example, the policy template may be formed in a mark-up language, such as the extensible Mark-up Language (XML) or the like. An example of a policy document including policy templates in XML may be:

```
<PolicyDocument>
<HeaderInformation>
<Policy>
  <precondition> if clause </precondition>
  <decision> then clause </decision>
</Policy>
<Policy>
...
</Policy >
</PolicyDocument>
```

Accordingly, the template may be in the form of an “if-then” clause or similar clause or statement, “if some precondition or preconditions, then some decision is made.” The decision may be to perform some action or function, set a value or some other action or inaction.

For example a template in XML may take the form, “if <licensed> and <authorization-level> then <function-performed>” where “licensed” might, for example, take on Boolean values, “true” or “false,” and may be indicative of whether a valid license to execute a program or access protected content is in place; <authorization-level> may be a numeric or ordinal value indicating one of a plurality of possible levels of authorization held by a user or other entity requesting an action; and “function-performed” may be a function or action, selected from among multiple possible functions or actions based on the licensing status and the authorization level of a user or entity requesting an action. Licensed, authorized-user and function-performed may be referred to as parameters, variables or values that can be specified and changed from time to time to update the template and associated policy.

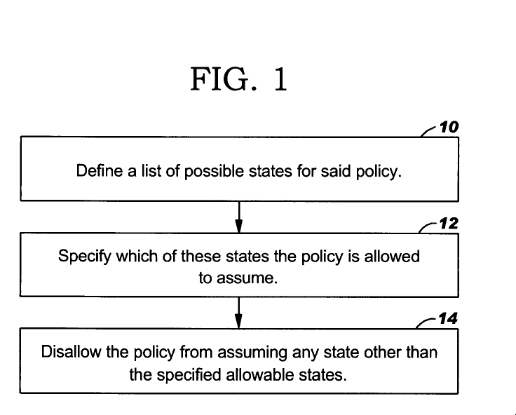

A policy template may assume one or more of a plurality of states, such as draft, validation, ready for deployment, deployed, dormant, expired, superceded, or the like, as necessary or desired for the application or system with respect to which the policy is created. According to the present invention, the policy may be prohibited from entering one or more states by defining allowable states for the policy, such as by an exemplary method depicted in flow diagram form in FIG. 1. A set of possible states for a policy is defined in step 10. This definition may take the form of a defined header set in an XML template, such as for example, <states> list of possible states </states>. Alternatively, the definition of allowable states may be inherently or explicitly defined at all enforcement or implementation points—that is, the system may simply “know” the possible states for policies, as may be appropriate and most efficient for isolated, stand-alone system with clearly defined or inherently limited possible policy states.

However defined, a list of allowable states for a given policy is specified, as indicated at step 12. The allowable states are preferably specified as part of the policy template. For example, eight possible states may be defined for a policy, numbered 1-8, with states 6 and 7 corresponding to deployed states. For an example policy that should never be deployed prior to customization to a user's environment, an XML template restricting the policy from assuming state 6 or 7 may take the following form:

```
<Policy>
  <policy-name> General Example </policy-name>
  <policy-scope> DB2 Examples </policy-scope>
  <desc> example policies cannot be deployed </desc>
  <allowable-states> 1,2,3,4,5,8 </allowable-states>
</Policy>
```

Alternatively, the allowable states may be specified in any manner known in the art, such as by a specification separate from the policy template. The allowable states specification is read by the enforcement or implementation point(s), at step 14, which then prohibit the policy from entering any state not indicated as allowable. In the above example, the enforcement or implementation point(s) would disallow any action or function that would place the policy in states 6 or 7.

In contrast to precluding a policy from assuming a deployed state, such as in the above example, once deployed a policy may be prohibited from being placed in an undeployed state (i.e., inactive, expired, dormant, or the like). This may be particularly relevant for policies that deal with security or financial issues, or control access, in which undeploying the policy would defeat the restrictions that the policy enforces. Additionally, a policy may be prohibited from entering a draft state, which may for example be the only state in which policies may be edited, to disallow users from changing the access preconditions written into the policy. In general, according to the present invention, a policy may be disallowed from any state or states, by specifying the only allowed states for the policy. In one embodiment, the allowable states portion of the policy is permanently read-only and cannot be edited, even when the policy is placed in an allowed state that permits editing other elements or rules of the policy.

FIG. 4 is an example of a system 400 to enforce allowed policy states in accordance with an embodiment of the present invention. The system 400 may include one or more policy administrators 402 and one or more enforcement points 404. Each policy administrator 402 may include a processor 406, one or more input devices 408 and one or more output devices 410. The processor 406, input devices 408 and output devices 410 may facilitate defining policy templates 412. An allowable states specification 415 defining the allowable states of the associated policy may be associated with the policy template 412 as shown for clarity, or may alternatively be a constituent element of the policy template 412. An ID 414 may optionally be assigned to each policy template 412. The processor 406, input devices 408 and output devices 410 may also facilitate transmitting one or both of the ID 414, or the policy template 412 together with its allowable states specification 415, associated with each policy to be enforced to the respective enforcement points 404 enforcing the policy.

The input devices 408 may include a keyboard, pointing device, voice recognition system or the like. The input devices 408 may also include optical, magnetic, infrared or radio frequency input devices or combination input/output devices, such as disk drives or the like. The input devices 408 may receive, read, or download software, computer-executable or readable instructions or the like, such as software 418 that may define allowable states of policies in specification 415. The software 418 may be downloaded from a communication network, system or medium such as network or medium 420. The communication network 420 or medium may be any communication system including by way of example, dedicated communication lines, telephone networks, wireless data transmission systems, two-way cable systems, customized computer networks, interactive kiosk networks, the Internet or the like. The system or medium 420 may also be or form part of a communication channel, memory or similar devices. The output devices 410 may include a display or monitor, printer audio system or the like. The output devices 410 may also be coupled to a communication system, network or medium, such as the network or medium 420. The processor 406 may also include a browser 414 or the like to facilitate accessing the network or medium 420.

Each enforcement point 404 may include a processor 424, one or more input devices 426 and one or more output devices 428. The processor 424, input devices 426 and output devices 428 may facilitate the enforcement point 404 receiving the ID 414 assigned to the policy template 412, or the policy template 412 itself together with an allowable states specification 415, for each policy to be enforced by the enforcement point 404. The processor 424, input devices 426 and output devices 428 may be similar to the processor 406, input devices 408 and output devices 410 of each policy administrator 402. The enforcement point processor 424 may also include software 430, computer-readable or computer-executable instructions or the like that may enforce allowable states of policies by disallowing, precluding or failing to perform functions or actions placing a policy in a disallowed state. Each enforcement point 404 may also include a browser 432 or the like to facilitate access to the communication network or medium 420. Each enforcement point 404 may also include a data source 434 that may store each policy template 412, allowable states specification 415, and the associated or assigned ID 414 for enforcement of the policy and its allowable states corresponding to the template 412 by the enforcement point 404. The data source 434 may also store parameters 416 bound to the template 412.

The system 400 may also include a repository 436 to store the policy templates 412, IDs 414 and allowable state specifications 415 assigned to each policy template 412. The repository 436 may also store parameters 416 or sets of parameters 416 associated with each policy template 412. The repository 436 may be populated with policy templates 412 and their associated IDs 414, allowable states specifications 415 and parameters 416 by policy administrators 402, according to known data communications methods. Policy administrators 402 may additionally update and otherwise manage policy data in the repository 436. An enforcement point 404 may extract a policy template 412, with associated allowable states specification 415 and parameters 416, from the repository 436 via known data communications methods. The enforcement point 404 may index the repository 436 by policy ID 414. The repository 436 may also include software and hardware to compress each policy template 412 and associated data before transmission to the enforcement point 404 to conserve resources. Alternatively, the policy templates 412 and associated data may be stored in a compressed format to further conserve resources.

The system 400 may also include a server 438, processor or the like to interface between each of the policy administrators 402, enforcement points 404 and repository 436. The server 438 may include software 440, computer-executable or computer-readable instructions or the like for operation of the system 400 in storing and distributing policy templates 412 and associated allowable states specification 415 and parameters 416.

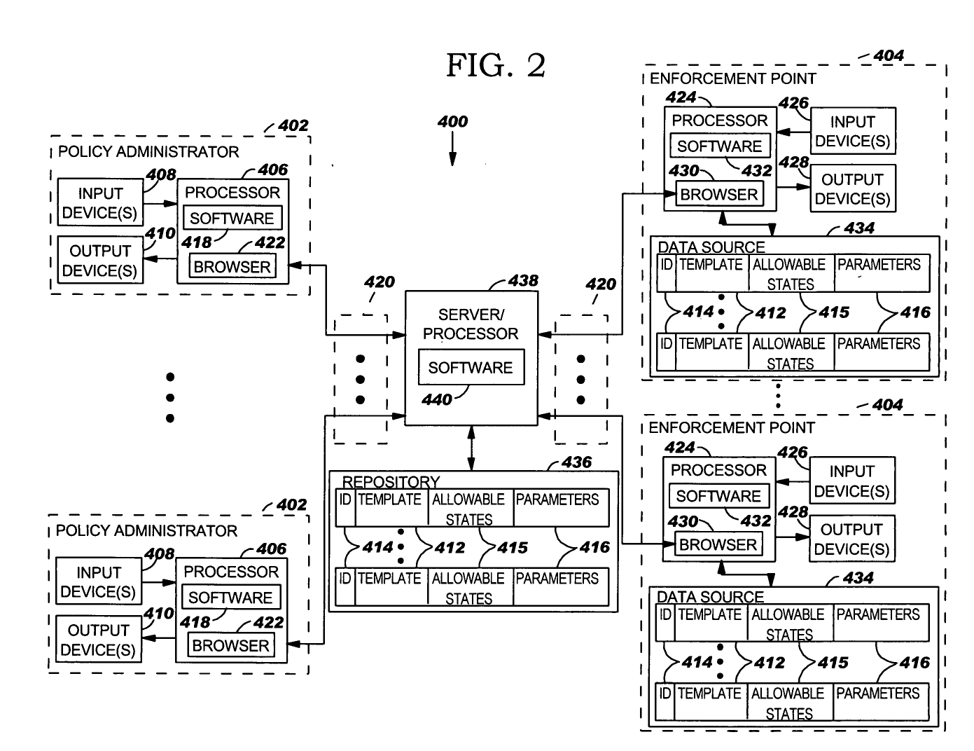

Methods of restricting policies to allowable states according to the present invention may be embodied in hardware and/or software as a computer program code that may include firmware, resident software, microcode or the like. Additionally, elements of the invention may take the form of a computer program product on a computer-usable or computer-readable storage medium having computer-usable or computer-readable program code embodied in the medium for use by or in connection with a system, such as system 400 of FIG. 2. Examples of such a medium may be illustrated in FIG. 2 as input devices 408 and 426 or network 420. Computer-usable or readable medium may be any medium that may contain, store, communicate or transport the program for use by or in connection with a system, such as system 400. The medium, for example, may be an electronic, magnetic, optical electromagnetic, infrared or semiconductor system or the like. The medium may also be simply a stream of information being retrieved when the computer program product is “downloaded” through a network, such as network 420, the Internet or the like. The computer-usable or readable medium could also be paper or another suitable medium upon which the program may be printed.

Although the present invention has been described herein with respect to particular features, aspects and embodiments thereof, it will be apparent that numerous variations, modifications, and other embodiments are possible within the broad scope of the present invention, and accordingly, all variations, modifications and embodiments are to be regarded as being within the scope of the invention. The present embodiments are therefore to be construed in all aspects as illustrative and not restrictive and all changes coming within the meaning and equivalency range of the appended claims are intended to be embraced therein.

1. A method of restricting a policy from assuming certain states comprising:
defining possible states for said policy; and
specifying which of said states are allowable states for said policy to assume.

2. The method of claim 1 further comprising disallowing, at an enforcement point or selected enforcement points, said policy from assuming any state other than said specified allowable states.

3. The method of claim 1 wherein specifying which of said states are allowable states for said policy to assume comprises:
defining an allowable states parameter; and
assigning one or more values to said allowable states parameter indicative of said allowable states.

4. The method of claim 3 wherein said allowable states parameter is delimited by a markup language header set.

5. The method of claim 4 wherein said markup language is XML.

6. The method of claim 5 wherein said header set comprises <allowable-states> and </allowable-states>.

7. The method of claim 6 wherein said allowable state values are listed between said <allowable-states> and </allowable-states> headers.

8. The method of claim 3 wherein said allowable states parameter values are read-only.

9. A system to disallow policies to assume certain states, comprising:
a policy administrator to define possible states for one or more policies and to specify which of said states are allowable states for said policies to assume; and
at least one enforcement point to enforce each policy, said enforcement point disallowing each said policy from assuming any said state other than said allowable states.

10. The system of claim 8 wherein said policy administrator comprises a processor to specify said allowable states for each said policy.

11. The system of claim 8 where each said enforcement point comprises a processor to disallow each said policy from assuming any said state other than said allowable states.

12. The system of claim 8 further comprising a repository to store a template associated with each said policy, said template including a list of said allowable states.

13. The system of claim 11, further comprising a server to interface between each policy administrator, each enforcement point and said repository.

14. A computer-readable medium having computer-executable instructions for causing a computer to perform the steps of:
defining possible states for said policy; and
specifying which of said states are allowable states for said policy to assume.

15. The computer-readable medium of claim 14 wherein specifying which of said states are allowable states for said policy to assume comprises:
defining an allowable states parameter; and
assigning one or more values to said allowable states parameter indicative of said allowable states.

16. A computer-readable medium having computer-executable instructions for causing a computer to perform the steps of:
receiving a policy having a plurality of possible states and specifying one or more allowable states;
enforcing said policy; and
disallowing said policy from assuming any state other than said allowable states.
